(19) United States
(12) Patent Application Publication
(10) Pub. No.: US 2009/0051643 A1
(43) Pub. Date: Feb. 26, 2009

(54) BACKLIGHT ASSEMBLY, DISPLAY APPARATUS HAVING THE SAME, METHOD FOR DRIVING THE SAME, AND METHOD FOR DRIVING THE DISPLAY APPARATUS

(75) Inventors: Yeun-Mo YEON, Hwasung-gun (KR); Ki-Seok CHA, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/102,080

(22) Filed: Apr. 14, 2008

(30) Foreign Application Priority Data
Aug. 20, 2007 (KR) 10-2007-0083514

(51) Int. Cl. G09G 3/36; H05B 37/02

(52) U.S. Cl. 345/102; 315/294; 345/55; 345/87

(57) ABSTRACT

In a backlight assembly, a display apparatus having the backlight assembly, a method for driving the backlight assembly and a method for driving the display apparatus, the backlight assembly includes a plurality of light sources and a light source driving unit. The light sources are disposed along a direction and emit light. The light source driving unit causes the light sources to sequentially emit light along the direction, and causes each of the light sources to emit light during a first emitting period of a time period, and then causes each of the light sources to emit light during a second emitting period of the time period. The time period is substantially the same as a single frame. Accordingly, each of the light sources emits light again after the light sources have emitted light once, so that motion blur in the display apparatus may be decreased.

This application claims priority to Korean Patent Application No. 2007-83514, filed on Aug. 20, 2007, and all the benefits accruing therefrom under 35 U.S.C. §119, the contents of which in its entirety are herein incorporated by reference.

### BACKGROUND OF THE INVENTION

1. Field of the Invention

The present invention relates to a backlight assembly, a display apparatus having the backlight assembly, a method for driving the backlight assembly and a method for driving the display apparatus. More particularly, the present invention relates to a backlight assembly that emits light via a scanning process, a display apparatus having the backlight assembly, a method for driving the backlight assembly and a method for driving the display apparatus.

2. Description of the Related Art

Generally, a liquid crystal display (“LCD”) apparatus is advantageous in that the LCD apparatus has a thin thickness, a light weight and low power consumption. Thus, LCD apparatuses are used not only for monitors, laptop computers and mobile phones but also for large-size televisions. An LCD apparatus includes an LCD panel and a backlight assembly. The LCD panel displays an image using the light transmissivity of liquid crystals. The backlight assembly provides light to the LCD panel.

The response time of the liquid crystals is limited, so that motion blur may occur when the LCD apparatus displays a moving image. In order to decrease the motion blur, backlight scanning technology, where light sources of the backlight assembly are synchronized with the LCD panel, the light sources are periodically turned on and off.

### BRIEF SUMMARY OF THE INVENTION

Although the conventional backlight assembly causes lamps to emit light using the backlight scanning technology, it has been determined herein according to the present invention that the motion blur may not be totally eliminated. For example, it has been determined herein according to the present invention that when the LCD apparatus having the conventional backlight assembly displays a movable image moving at high speed, the motion blur may easily occur.

The present invention provides a backlight assembly capable of decreasing motion blur.

The present invention also provides a display apparatus having the backlight assembly.

The present invention also provides a method for driving the backlight assembly.

The present invention also provides a method for driving the display apparatus.

In an exemplary backlight assembly according to the present invention, the backlight assembly includes a plurality of light sources and a light source driving unit. The light sources are disposed along a direction and emit light. The light source driving unit causes the light sources to sequentially emit light along the direction, and causes each of the light sources to emit light during a first emitting period of a time period, and then causes each of the light sources to emit light during a second emitting period of the time period. The time period is substantially same as a single frame. The second emitting period may be longer than the first emitting period.

The light source driving unit may further cause each of the light sources to emit light during a third emitting period of the time period, after causing each of the light sources to emit light during the second emitting period of the time period. The third emitting period may be longer than the first emitting period. The third emitting period may be substantially the same as the second emitting period.

The second emitting period may be separated from the first emitting period by a first non-emitting period and the third emitting period may be separated from the second emitting period by a second non-emitting period.

The light source driving unit may include power supply parts and a light source control part. The power supply parts are electrically connected to the light sources, respectively, and provide driving power sources to the light sources. The light source control part may control the power supply parts, so that the light sources may sequentially emit light along the direction and each of the light sources may emit light during the second emitting period after each of the light sources emits light during the first emitting period.

The light source driving unit may cause the light sources to emit light during the second emitting period of the time period after a non-emitting period following the first emitting period has elapsed.

In an exemplary display substrate according to the present invention, the display apparatus includes a display module and a backlight assembly.

The display module displays an image. The backlight assembly may include a plurality of light sources and a light source driving unit. The light sources are disposed along a first direction and emit light. The light source driving unit causes the light sources to sequentially emit light along the first direction corresponding to a timing of the image displayed on the display module, and causes each of the light sources to emit light during a first emitting period of a time period and then causes each of the light sources to emit light during a second emitting period of the time period. The time period is substantially the same as a single frame. The second emitting period may be longer than the first emitting period.

The display module may include a liquid crystal display (“LCD”) panel, a gate driving part, a data driving part and a timing control part. The LCD panel may include a plurality of gate lines arranged along the first direction with respect to each other and a plurality of data lines arranged with respect to each other along a second direction substantially perpendicular to the first direction, and may display the image by changing a longitudinal arrangement direction of liquid crystals. The gate driving part may sequentially provide gate signals to the gate lines along the first direction. The data driving part may provide data signals to the data lines. The timing control part may control the gate and data driving parts.

The light source driving unit may cause each of the light sources to emit light during the first emitting period, after movements of the liquid crystals are over. The light source driving unit may cause the light sources to sequentially emit light along the first direction corresponding to a timing of the gate signals.

The timing control part may provide a vertical start signal to the light source driving unit. The vertical start signal may inform of a start or an end of the single frame to display a single screen image. The light source driving unit may include power supply parts and a light source control part. The power supply parts may be electrically connected to the light sources, respectively, and may provide driving power sources to the light sources. The light source control part may control the power supply parts, so that the light sources may sequentially emit light along the first direction and each of the light sources may emit light during the second emitting period after each of the light sources emits light during the first emitting period.

In an exemplary method for driving a backlight assembly according to the present invention, the method includes causing each of light sources to emit light during a first emitting period of a time period. The time period is substantially the same as a single frame. The light sources sequentially emit light along a direction. Each of the light sources emits light during a second emitting period of the time period, after each of the light sources emits light during the first emitting period of the time period. The second emitting period may be longer than the first emitting period.

The method may further include causing each of the light sources to emit light during a third emitting period of the time period, after causing each of the light sources to emit light during the second emitting period of the time period. The third emitting period may be longer than the first emitting period.

In an exemplary method for driving a display apparatus according to the present invention, the method includes sequentially applying gate signals to a display panel along a direction. Light sources sequentially emit light along the direction, and the light sources are synchronized with the gate signals.

The light sources sequentially emit light by causing each of the light sources to emit light during a first emitting period of a time period, and causing each of the light sources to emit light during a second emitting period of the time period, after causing each of the light sources to emit light during the first emitting period of the time period. The time period is substantially the same as a single frame. The second emitting period may be longer than the first emitting period.

Each of the light sources may emit light during the first emitting period by changing a longitudinal arrangement direction of liquid crystals in the display panel using the gate signals and using data signals, and causing each of the light sources to emit light during the first emitting period, after movements of the liquid crystals are over.

According to the present invention, light sources emit light again after the light sources have emitted light once, so that motion blur may be prevented in a display apparatus. For example, each of the light sources may emit light during a first emitting period, and then each of the light sources may emit light during a second emitting period to compensate for brightness loss, so that the motion blur may be prevented.

### BRIEF DESCRIPTION OF THE DRAWINGS

The above and other features and advantages of the present invention will become more apparent by describing in detailed exemplary embodiments thereof with reference to the accompanying drawings, in which:

FIG. 1 is a block diagram illustrating an exemplary display apparatus according to an exemplary embodiment of the present invention;

FIG. 2 is a plan view illustrating the exemplary backlight assembly of the exemplary display apparatus in FIG. 1;

FIG. 3 shows waveform diagrams illustrating light source control signals inside of the exemplary backlight assembly in FIG. 2;

FIG. 4 shows a waveform diagram illustrating an exemplary embodiment of a first light source control signal of the light source control signals in FIG. 3; and

FIG. 5 shows a waveform diagram illustrating another exemplary embodiment of the first light source control signal of the light source control signals in FIG. 3.

### DETAILED DESCRIPTION OF THE INVENTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, a first element, component, region, layer or section discussed below could be termed a second element, component, region, layer or section without departing from the teachings of the present invention.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, the present invention will be described in detail with reference to the accompanying drawings.

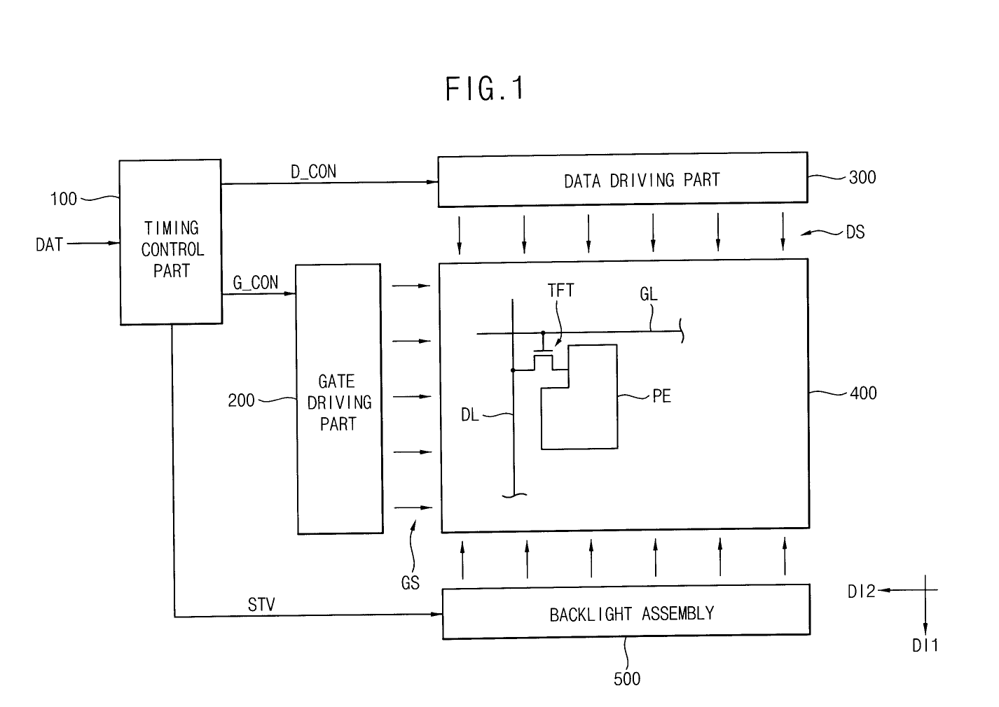

FIG. 1 is a block diagram illustrating an exemplary display apparatus according to an exemplary embodiment of the present invention.

Referring to FIG. 1, the display apparatus according to the present exemplary embodiment includes a display module and a backlight assembly 500. The display module displays an image using light. The backlight assembly 500 provides the light to the display module.

The display module includes a timing control part 100, a gate driving part 200, a data driving part 300 and a display panel 400.

The timing control part 100 receives an image control signal DAT from an external graphic controller (not shown). The timing control part 100 may output a gate driving signal G_CON, a data driving signal D_CON and a vertical start signal STV, in response to the image control signal DAT. The gate driving signal G_CON includes the vertical start signal STV informing of a start or an end of a single frame.

The gate driving part 200 receives the gate driving signal G_CON from the timing control part 100. The gate driving part 200 sequentially outputs gate signals GS along a first direction DI1, in response to the gate driving signal G_CON.

The data driving part 300 receives the data driving signal D_CON from the timing control part 100. The data driving part 300 outputs data signals DS, in response to the data driving signal D_CON.

The display panel 400 externally displays the image, in response to the gate signals GS applied from the gate driving part 200 and the data signals DS applied from the data driving part 300.

The display panel 400 may include a first substrate (not shown), a second substrate (not shown) opposite to the first substrate, and a liquid crystal layer (not shown) disposed between the first and second substrates.

The first substrate includes a plurality of gate lines GL, a plurality of data lines DL, a plurality of thin film transistors TFT and a plurality of pixel electrodes PE.

The gate lines GL extend substantially in the second direction DI2 and are arranged along the first direction DI1 substantially parallel to each other. The gate lines GL sequentially receive the gate signals GS along the first direction DI1 from the gate driving part 200.

The data lines DL extend substantially in the first direction DI1 and are arranged along a second direction DI2 crossing the first direction DI1. The data lines DL receive the data signals DS from the data driving part 300. The first and second directions DI1 and DI2 may be substantially perpendicular to each other.

Each of the thin film transistors TFT includes a control electrode, an input electrode and an output electrode. The control electrode, also known as a gate electrode, is electrically connected to one of the gate lines GL, and the input electrode, also known as a source electrode, is electrically connected to one of the data lines DL. The pixel electrodes PE are electrically connected to output terminals, also known as drain electrodes, of the thin film transistors TFT, respectively.

The second substrate may include a plurality of color filters and a common electrode. The color filters correspond to the pixel electrodes PE. The common electrode may be formed on the entire second substrate, or substantially the entire second substrate, and has a transparent conductive material. For example, the color filters may include red color filters, green color filters and blue color filters.

The liquid crystal layer is disposed between the first and second substrates, and a longitudinal arrangement direction of liquid crystals in the liquid crystal layer is changed by an electric field formed between the pixel electrodes PE and the common electrode. When the longitudinal arrangement direction of the liquid crystals is changed, a transmissivity of the light transmitting through the liquid crystal layer is changed.

The display panel 400 is driven as follows. When the gate signal GS is applied to the gate line GL, the thin film transistor TFT is turned on. When the thin film transistor TFT is turned on, the data signal DS applied to the data line DL is applied to the pixel electrode PE through a channel layer of the thin film transistor TFT, to charge the pixel electrode PE. When the pixel electrode PE is charged, the electric field is generated between the pixel electrode PE and the common electrode, so that the electric field changes the longitudinal arrangement direction of the liquid crystals in the liquid crystal layer.

Thus, a predetermined time is required from a start of applying the gate signal GS to the gate line GL, to an end of movements of the liquid crystals. The predetermined time is called a liquid crystal delay time or a liquid crystal response time.

The backlight assembly 500 is disposed under the display panel 400, to provide the light to the display panel 400. The backlight assembly 500 is controlled by the vertical start signal STV applied from the timing control part 100, to provide the light to the display panel 400.

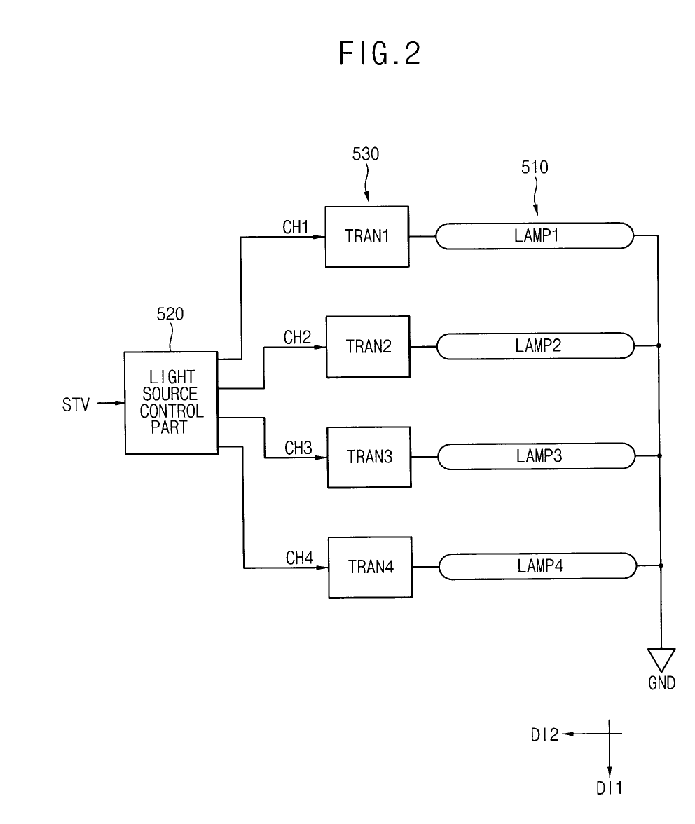

FIG. 2 is a plan view illustrating the exemplary backlight assembly of the exemplary display apparatus in FIG. 1.

Referring to FIGS. 1 and 2, the backlight assembly includes a plurality of light sources 510 and a light source driving unit.

The light sources 510 are arranged along the first direction DI1 so as to be at least substantially parallel to each other. Each of the light sources 510 may be a cold cathode fluorescent lamp (“CCFL”) having a bar shape or a U-shape. Alternatively, the light sources 510 may be a hot cathode fluorescent lamp (“HCFL”) or an external electrode fluorescent lamp (“EEFL”).

For example, the number of the light sources 510 may be four. While a particular number of light sources 510 and associated elements will be described, it should be understood that an alternate number of light sources 510 and associated elements would be within the scope of these embodiments and that the number four is used for illustrative purposes only. In the exemplary embodiment including four light sources 510, first, second, third and fourth lamps LAMP1, LAMP2, LAMP3, and LAMP4 may be disposed adjacent to each other along the first direction DI1 in parallel.

The light source driving unit causes the light sources 510 to sequentially emit light along the first direction DI1, and causes each of the light sources 510 to emit light during a second emitting period of a time period after causing each of the light sources 510 to emit light during a first emitting period of the time period. The time period is substantially the same as the single frame of the display panel 400. For example, the light source driving unit may include a light source control part 520 and a power supply part 530.

The light source control part 520 receives the vertical start signal STV from the timing control part 100. The light source control part 520 outputs light source control signals to the power supply part 530, in response to the vertical start signal STV.

The power supply part 530 applies driving voltages to each of the light sources 510, in response to the light source control signals applied from the light source control part 520. The power supply part 530 is controlled by the light source control signals, so that the light sources 510 sequentially emit light along the first direction DI1 and the light sources 510 emit light during the second emitting period of the time period after the light sources 510 emit light during the first emitting period of the time period.

For example, in the exemplary embodiment of a backlight assembly 500 including four light sources 510, the power supply part 530 may include four transformers TRAN1, TRAN2, TRAN3, and TRAN4. The power supply part 530 may include a first transformer TRAN1 applying a first driving voltage to the first lamp LAMP1, a second transformer TRAN2 applying a second driving voltage to the second lamp LAMP2, a third transformer TRAN3 applying a third driving voltage to the third lamp LAMP3, and a fourth transformer TRAN4 applying a fourth driving voltage to the fourth lamp LAMP4. In addition, the light source control part 520 may output first, second, third and fourth light source control signals CH1, CH2, CH3 and CH4, to control the first, second, third and fourth transformers TRAN1, TRAN2, TRAN3, and TRAN4.

First terminals of the first, second, third and fourth lamps LAMP1, LAMP2, LAMP3, and LAMP4 may be electrically connected to the first, second, third and fourth transformers TRAN1, TRAN2, TRAN3, and TRAN4, respectively. As in the illustrated exemplary embodiment, second terminals of the first, second, third and fourth lamps LAMP1, LAMP2, LAMP3, and LAMP4 may be electrically connected to a ground GND. Alternatively, the second terminals of the first, second, third and fourth lamps LAMP1, LAMP2, LAMP3, and LAMP4 may be electrically connected to other transformers (not shown). In addition, the second terminals of the first, second, third and fourth lamps LAMP1, LAMP2, LAMP3, and LAMP4 may be electrically connected to the first, second, third and fourth transformers TRAN1, TRAN2, TRAN3, and TRAN4, respectively.

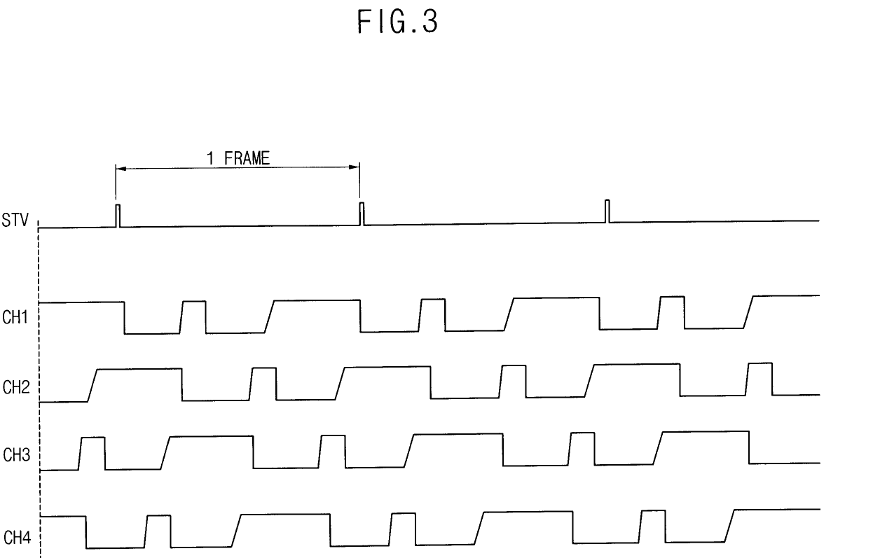

FIG. 3 shows waveform diagrams illustrating light source control signals inside of the exemplary backlight assembly in FIG. 2.

Referring to FIGS. 1, 2 and 3, the light source control part 520 outputs the first light source control signal CH1 synchronized with the vertical start signal STV. The first light source control signal CH1 controls the first transformer TRAN1, so that the first lamp LAMP1 emits light during the second emitting period of the time period after the first lamp LAMP1 emits light during the first emitting period of the time period. In this case, as mentioned above, the time period is substantially the same as the single frame.

The light source control part 520 outputs the second light source control signal CH2 after a predetermined delay time has passed since the first light source control signal CH1 was outputted. The second light source control signal CH2 controls the second transformer TRAN2, so that the second lamp LAMP2 emits light via substantially the same process as that through which the first lamp LAMP1 emits light.

The light source control part 520 outputs the third light source control signal CH3 after a predetermined delay time has passed since the second light source control signal CH2 was outputted. The third light source control signal CH3 controls the third transformer TRAN3, so that the third lamp LAMP3 emits light via substantially the same process as that through which the first lamp LAMP1 emits light.

The light source control part 520 outputs the fourth light source control signal CH4 after a predetermined delay time has passed since the third light source control signal CH3 was outputted. The fourth light source control signal CH4 controls the fourth transformer TRAN4, so that the fourth lamp LAMP4 emits light via substantially the same process as that through which the first lamp LAMP1 emits light.

The first, second, third and fourth light source control signals CH1, CH2, CH3 and CH4 correspond to a timing of the vertical start signal STV, so that the first, second, third and fourth light source control signals CH1, CH2, CH3 and CH4 may respectively correspond to timings of the gate signals GS sequentially applied to the gate lines GL along the first direction DI1.

The first, second, third and fourth light source control signals CH1, CH2, CH3 and CH4 may respectively control the first, second, third and fourth transformers TRAN1, TRAN2, TRAN3, and TRAN4, so that the first, second, third and fourth lamps LAMP1, LAMP2, LAMP3, and LAMP4 emit light after the gate signals GS are applied to the gate lines GL and the movements of the liquid crystals in the liquid crystal layer are over.

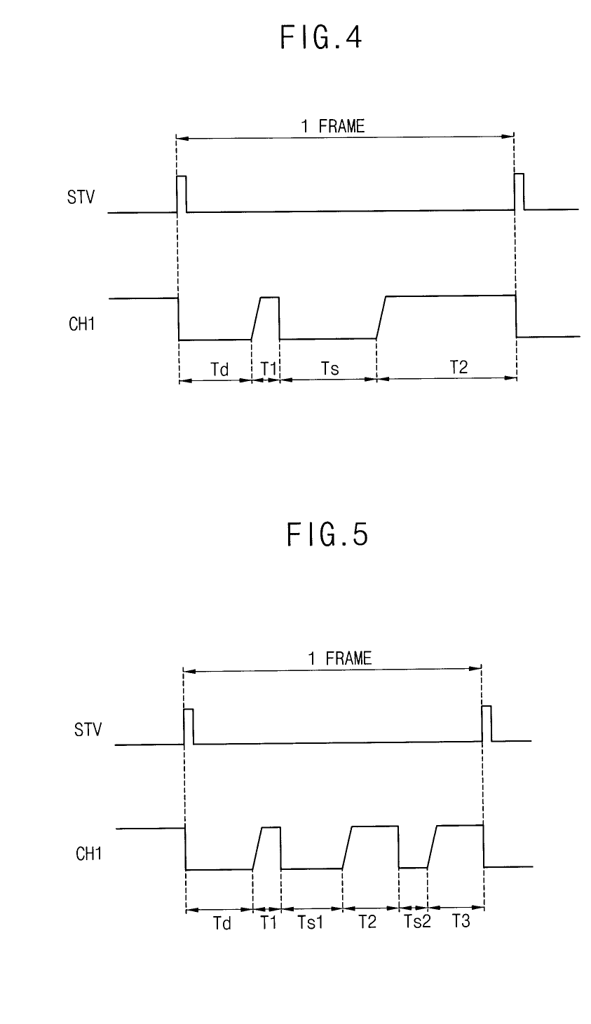

FIG. 4 shows a waveform diagram illustrating an exemplary embodiment of a first light source control signal of the light source control signals in FIG. 3.

Referring to FIG. 4, the first light source control signal CH1 may have a low voltage during a liquid crystal delay period Td from the start of applying the vertical start signal STV, and may have a high voltage during the first emitting period T1 after the liquid crystal delay period Td. In addition, the first light source control signal CH1 may have the low voltage during a non-emitting period Ts after the first emitting period T1, and may have the high voltage during the second emitting period T2 after the non-emitting period Ts.

The liquid crystal delay period Td, the first emitting period T1, the non-emitting period Ts and the second emitting period T2 may be included in the time period substantially the same as the single frame of the display panel 400. The time period is from the start of one vertical start signal STV to the start of a subsequent vertical start signal STV. In an exemplary embodiment, the second emitting period T2 may be longer than the first emitting period T1.

When the first light source control signal CH1 is applied to the first transformer TRAN1, the first lamp LAMP1 does not emit light during the liquid crystal delay period Td from the start of applying the vertical start signal STV, and the first lamp LAMP1 emits light during the first emitting period T1 which follows the liquid crystal delay period Td. Then, the first lamp LAMP1 does not emit light during the non-emitting period Ts, which follows the first emitting period T1, and then the first lamp LAMP1 emits light during the second emitting period T2, which follows the non-emitting period Ts.

When the first lamp LAMP1 does not emit light during the liquid crystal delay period Td from the start of applying the vertical start signal STV and then emits light during the first emitting period T1, the first lamp LAMP1 may emit light after the end of the movements of the liquid crystals in the liquid crystal layer.

The first light source control signal CH1 has been described above referring to FIG. 4, but the second, third and fourth light source control signals CH2, CH3 and CH4 may have substantially the same signal waveform as the first light source control signal CH1. The second, third and fourth light source control signals CH2, CH3 and CH4 may have first emitting periods T1 that are consecutively delayed with respect to the first emitting period T1 of the first light source control signal CH1.

FIG. 5 shows a waveform diagram illustrating another exemplary embodiment of the first light source control signal of the light source control signals in FIG. 3.

Referring to FIG. 5, the first light source control signal CH1 according to the present exemplary embodiment, may have a signal waveform different from the signal waveform illustrated in FIG. 4.

For example, the first light source control signal CH1 may have the low voltage during the liquid crystal delay period Td from the start of applying the vertical start signal STV, and may have the high voltage during the first emitting period T1 after the liquid crystal delay period Td. In addition, the first light source control signal CH1 may have the low voltage during a first non-emitting period Ts1 after the first emitting period T1, and may have the high voltage during the second emitting period T2 after the first non-emitting period Ts1. In addition, the first light source control signal CH1 may have the low voltage during a second non-emitting period Ts2 after the second emitting period T2, and have the high voltage during a third emitting period T3 after the second non-emitting period Ts2.

In this case, the liquid crystal delay period Td, the first emitting period T1, the first non-emitting period Ts1, the second emitting period T2, the second non-emitting period Ts2 and the third emitting period T3 may be included in the time period which is substantially the same as the single frame of the display panel 400. The second emitting period T2 and the third emitting period T3 may be longer than the first emitting period T1. The second emitting period T2 and the third emitting period T3 may be substantially the same as each other.

When the first light source control signal CH1 is applied to the first transformer TRAN1, the first lamp LAMP1 does not emit light during the liquid crystal delay period Td from the start of applying the vertical start signal STV, and the first lamp LAMP1 emits light during the first emitting period T1. Then, the first lamp LAMP1 does not emit light during the first non-emitting period Ts1, and the first lamp LAMP1 emits light during the second emitting period T2. Then, the first lamp LAMP1 does not emit light during the second non-emitting period Ts2, and the first lamp LAMP1 emits light during the third emitting period T3.

The first light source control signal CH1 has been described above referring to FIG. 5, but the second, third and fourth light source control signals CH2, CH3 and CH4 may have substantially the same signal waveform as the first light source control signal CH1.

Referring to FIGS. 1 to 5, an exemplary method for driving the exemplary display apparatus according to the exemplary embodiments of the present invention may be described as follows.

The gate signals GS are sequentially applied to the gate lines GL of the display panel 400 along the first direction DI1. In this case, the gate lines GL are arranged with respect to each other along the first direction DI1. When the gate signals GS are applied to the gate lines GL, the data signals DS may be applied to the data lines DL of the display panel 400 that are arranged with respect to each other along the second direction DI2.

The gate signals GS may be generated from the gate driving part 200, and the data signals DS may be generated from the data driving part 300. The gate driving part 200 and the data driving part 300 may be controlled by the timing control part 100.

The light sources 510 sequentially emit light along the first direction DI1, corresponding to the timing of the gate signals GS. For example, the light sources 510 may be synchronized with the gate signals GS sequentially applied to the gate lines GL along the first direction DI1, to emit light along the first direction DI1.

Each of the light sources 510 sequentially emitted along the first direction DI1, may be driven as follows.

First, each of the light sources 510 emits light during the first emitting period T1 of the time period substantially the same as the single frame of the display panel 400. Before each of the light sources 510 emits light during the first emitting period T1, the longitudinal arrangement direction of the liquid crystals in the liquid crystal layer is changed by the gate and data signals GS and DS. For example, each of the light sources 510 may emit light during the first emitting period T1 after the end of the movements of the liquid crystals, that is, after the liquid crystal delay period Td.

Each of the light sources 510 emits light during the first emitting period T1, and then each of the light sources 510 emits light during the second emitting period T2 of the time period. The second emitting period T2 may follow a non-emitting period Ts. For example, the second emitting period T2 may be longer than the first emitting period T1.

The liquid crystal delay period Td, the first emitting period T1, the non-emitting period Ts and the second emitting period T2 may total the time period which is the same amount of time as one frame of the display panel 400. Alternatively, after each of the light sources 510 emits light during the second emitting period T2, each of the light sources 510 may then be further emitted during the third emitting period T3 of the time period. A second non emitting period Ts2 may follow the second emitting period T2. For example, the third emitting period T3 may be longer than the first emitting period T1, and the third emitting period T3 may be substantially the same as the second emitting period T2. In this exemplary embodiment, the liquid crystal delay period Td, the first emitting period T1, a first non-emitting period Ts1, the second emitting period T2, the second non-emitting period Ts2, and the third emitting period T3 may total the time period which is the same amount of time as one frame of the display panel 400.

The exemplary embodiments of the present invention described above include the light sources 510 each of which emits light two or three times during the time period, but each of the light sources 510 may emit light four or more than four times during the time period.

As in the exemplary embodiments described above, each of the light sources 510 that is sequentially emitted along the first direction DI1 emits light during the first emitting period T1, and then each of the light sources 510 emits light during the second emitting period T2, so that motion blur may be decreased in the display panel 400.

For example, when each of the light sources 510 emits light for a short period, the motion blur may be decreased in driving a movable image. However, when each of the light sources 510 emits light for the short period, the brightness of the display apparatus may be decreased. Thus, each of the light sources 510 emits light for the short period during the first emitting period Ti and then emits light at least one more time during the second emitting period T2, and then possibly additionally during the third emitting period T3 and subsequent emitting periods, so that the brightness of the display apparatus may be enhanced. For example, each of the light sources 510 may emit light for the short period to decrease the motion blur, and each of the light sources 510 may emit light at least one more time to enhance the brightness of the display apparatus.

According to the present invention, light sources emit light again after the light sources have emitted light once, so that motion blur may be prevented in a display apparatus. For example, each of the light sources may emit light during a first emitting period, and then each of the light sources may emit light during a second emitting period to compensate for brightness loss, so that the motion blur may be prevented and brightness is not deteriorated.

Having described the exemplary embodiments of the present invention and its features and advantages, it is noted that various changes, substitutions and alterations can be made herein without departing from the spirit and scope of the invention as defined by appended claims.

What is claimed is:

1. A backlight assembly comprising:
a plurality of light sources disposed along a direction and emitting light; and
a light source driving unit which causes the light sources to sequentially emit light along the direction, and which causes each of the light sources to emit light during a first emitting period of a time period and then causes each of the light sources to emit light during a second emitting period of the time period, the time period being substantially same as a single frame.

2. The backlight assembly of claim 1, wherein the second emitting period is longer than the first emitting period.

3. The backlight assembly of claim 1, wherein the light source driving unit further causes each of the light sources to emit light during a third emitting period of the time period after causing each of the light sources to emit light during the second emitting period of the time period.

4. The backlight assembly of claim 3, wherein the second emitting period is separated from the first emitting period by a first non-emitting period and the third emitting period is separated from the second emitting period by a second non-emitting period.

5. The backlight assembly of claim 3, wherein the third emitting period is longer than the first emitting period.

6. The backlight assembly of claim 5, wherein the third emitting period is substantially same in duration as the second emitting period.

7. The backlight assembly of claim 1, wherein the light source driving unit comprises:
power supply parts electrically connected to the light sources, respectively, and which provide driving power sources to the light sources; and
a light source control part which controls the power supply parts, so that the light sources sequentially emit light along the direction and each of the light sources emits light during the second emitting period after each of the light sources emits light during the first emitting period.

8. The backlight assembly of claim 1, wherein the light source driving unit causes the light sources to emit light during the second emitting period of the time period after a non-emitting period following the first emitting period has elapsed.

9. A display apparatus comprising:
a display module which displays an image; and
a backlight assembly including:
a plurality of light sources which are disposed along a first direction and emit light; and
a light source driving unit which causes the light sources to sequentially emit light along the first direction corresponding to a timing of the image displayed on the display module, and which causes each of the light sources to emit light during a first emitting period of a time period, and then causes each of the light sources to emit light during a second emitting period of the time period, the time period being substantially same as a single frame.

10. The display apparatus of claim 9, wherein the display module comprises:
a liquid crystal display panel including a plurality of gate lines arranged along the first direction with respect to each other and a plurality of data lines arranged with respect to each other along a second direction substantially perpendicular to the first direction, and which displays the image by changing a longitudinal arrangement direction of liquid crystals;
a gate driving part sequentially providing gate signals to the gate lines along the first direction;
a data driving part providing data signals to the data lines; and
a timing control part controlling the gate and data driving parts.

11. The display apparatus of claim 10, wherein the light source driving unit causes each of the light sources to emit light during the first emitting period, after movements of the liquid crystals are over.

12. The display apparatus of claim 10, wherein the light source driving unit causes the light sources to sequentially emit light along the first direction corresponding to a timing of the gate signals.

13. The display apparatus of claim 12, wherein the timing control part provides a vertical start signal to the light source driving unit, and the vertical start signal informs of a start or an end of the single frame to display a single screen image.

14. The display apparatus of claim 13, wherein the light source driving unit comprises:
power supply parts electrically connected to the light sources, respectively, and which provide driving power sources to the light sources; and
a light source control part which controls the power supply parts, so that the light sources sequentially emit light along the first direction and each of the light sources emits light during the second emitting period after each of the light sources emits light during the first emitting period.

15. The display apparatus of claim 9, wherein the second emitting period is longer than the first emitting period.

16. The backlight assembly of claim 9, wherein the light source driving unit causes the light sources to emit light during the second emitting period of the time period after a non-emitting period following the first emitting period has elapsed.

17. A method for driving a backlight assembly, the method comprising:
causing each of light sources to emit light during a first emitting period of a time period, the time period being substantially same as a single frame, the light sources being sequentially emitted along a direction; and
emitting each of the light sources during a second emitting period of the time period, after causing each of the light sources to emit light during the first emitting period of the time period.

18. The method of claim 17, wherein the second emitting period is longer than the first emitting period.

19. The method of claim 17, further comprising causing each of the light sources to emit light during a third emitting period of the time period, after causing each of the light sources to emit light during the second emitting period of the time period.

20. The method of claim 19, wherein the third emitting period is longer than the first emitting period.

21. The method of claim 17, wherein the light source driving unit causes the light sources to emit light during the second emitting period of the time period after a non-emitting period following the first emitting period has elapsed.

22. A method for driving a display apparatus, the method comprising:
sequentially applying gate signals to a display panel along a direction; and
sequentially emitting light sources along the direction, the light sources being synchronized with the gate signals,
wherein the light sources sequentially emit light by:
causing each of the light sources to emit light during a first emitting period of a time period, the time period being substantially same as a single frame; and
causing each of the light sources to emit light during a second emitting period of the time period, after causing each of the light sources to emit light during the first emitting period of the time period.

23. The method of claim 22, wherein each of the light sources emits light during the first emitting period by:
changing a longitudinal arrangement direction of liquid crystals in the display panel using the gate signals and using data signals; and
causing each of the light sources to emit light during the first emitting period, after movements of the liquid crystals are over.

24. The method of claim 22, wherein the second emitting period is longer than the first emitting period.

25. The method of claim 22, wherein the light source driving unit causes the light sources to emit light during the second emitting period of the time period after a non-emitting period following the first emitting period has elapsed.
